(19) United States
(12) Patent Application Publication
(10) Pub. No.: US 2009/0231339 A1
(43) Pub. Date: Sep. 17, 2009

(54) SYSTEM, METHOD AND PRODUCT FOR GRAPHICALLY DISPLAYING PROJECT STATUS INFORMATION

(75) Inventors: Wendy S. Smith, Ottawa (CA); Michael J. Heffernan, Ottawa (CA)

Correspondence Address: HESLIN ROTHENBERG FARLEY & MESITI PC, 5 COLUMBIA CIRCLE, ALBANY, NY, 12203, US

(73) Assignee: OpusEdge Inc., Ottawa (CA)

(21) Appl. No.: 12/045,775

(22) Filed: Mar. 11, 2008

(51) Int. Cl. G06T 11/20

(52) U.S. Cl. 345/440

(57) ABSTRACT

Management graphical display computer software and system associated with a project, and method of providing such graphical display to a user is described. The graphical display presents project information in a way that allows the user to view project status and information comprising at least three distinct project attributes in the form of a colored, shaded, or patterned project status triangle. Each vertex on the triangle represents a quantified project attribute measured on a radar graph having three axes, each axis corresponding to one of three project attributes. The optional addition of color, shading, or a pattern to the triangle can be correlated to a fourth quantified project attribute. The resulting unique triangle represents a given project condition in four dimensions. The user can quantitatively compare a reference triangle, such as an average of similar projects, to one or more current status triangles representing current or alternative plans overlaid on the same axes, each status triangle defining a distinct project condition.

### FIELD OF INVENTION

This invention relates generally to project management user applications, and more specifically to computer implemented graphical displays of information in the form of one or more triangles configured on the basis of a radar graph, for displaying project status information.

### BACKGROUND

Project management user applications abound in many forms today, and have become important tools for managing and tracking the progress of a project or projects (wherein project could be a project, project segment or project scope). Current user applications, however, require a great deal of effort to learn and use and deliver relatively limited information in a conventional table and/or graphic manner.

Current user applications typically display project information using graphical representations. Well-known applications in the art include Gantt Charts for displaying tasks and task durations, bar charts or resource graphs for displaying required resource hours versus time, and network diagrams showing task sequences. These applications show different project attributes, with the available views restricted based on the type of project element being displayed (i.e. Gantt charts are for tasks, Resource Graphs are for resources). Additionally, a limited set of attributes are typically shown in different views making a comprehensive view of the project difficult.

Projects are most often evaluated as to whether the required content will be completed by the scheduled date with the available resources. Thus the three main attributes for project evaluation are content, schedule and resources. Within the established project management methodology, it is not uncommon to depict the three attributes of content, schedule and resources as a triangle (often referred to as a project triangle) indicating that the three attributes are constrained such that improvements in one attribute are usually only obtained at the expense of the other attributes. In these cases, the project triangle is a descriptive qualitative depiction where the shape of the triangle is arbitrary and comparison between project triangles is qualitative rather than quantitative. Such qualitative comparisons are necessarily subjective. This triangle concept would be greatly enhanced if the three project attributes could be evaluated through quantitative metrics in a consistent manner at varying levels of project scope. Further, this concept of a project triangle would become a more useful management device if these metrics could be algorithmically generated by a project management application and automatically updated to reflect changes in the project plan.

The attributes of content, resources and schedule as planned for a project provide no indication as to whether the project as planned is feasible or achievable. In many scenarios, different variations on an initial project plan are possible. A fourth metric, indicating the feasibility of the possible project plans, is required to make informed choices between the possible project variations. Again, as a project management device, this fourth metric should be quantitatively evaluated in a consistent manner for varying levels of project scope and automatically updated to reflect changes in the project plan and to compare between alternate scenarios possible for the project plan. During execution of the project, results to date may change the feasibility or achievability of the remainder of the project. As such, this fourth metric may be viewed as representing the status of the current plan with respect to the feasibility of achieving the end results.

Project management would be greatly facilitated if these key project evaluation metrics (content, resources, schedule and status) were available in a comprehensive visual display. Additionally, these metrics should be available for a variety of scopes both at the level of the project, across multiple projects and at the detailed level of various parts or segments of the project. The display for different scopes should be based on a common design with a common algorithmic evaluation of the quantitative values. This invention responds to the need to define a new user interface design that presents increased information in a more compact form that is accessible and intuitive.

### SUMMARY

This invention provides a system, method, and computer software product for displaying project information in the form of triangles based on a common radar graph for use in presenting project status information useful for comparison purposes.

In one embodiment of the invention, computer software configured for presenting information regarding a project comprising at least four project attributes is provided. The computer software is embodied in computer-readable media and when executed operates to display within a graphical display workspace at least one triangle comprising three vertices and configured on the basis of a radar graph. The radar graph has three axes, and each of the axes represents a different one of the project attributes. Each vertex of the triangle is positioned at a location on a different one of the axes to represent a different quantified project attribute for a predetermined project condition. The triangle may also include one of a color, shading and pattern scaled to represent a fourth quantified project attribute.

In another embodiment of the invention, computer software configured for presenting information pertaining to one or more projects, each project comprising at least three project attributes, is provided. The computer software is embodied in computer-readable media and when executed operates to display within a graphical display workspace a first triangle and at least a second triangle. Each triangle has three vertices and is configured on the basis of a common radar graph having three axes.

The triangles may be overlapping on one radar graph, or may be shown separately on common radar graphs. Each axis of the radar graph represents a different one of the project attributes. The vertexes of each triangle are positioned at locations on different axes of the radar graph to represent a different quantified project attribute for a predetermined project condition. The project condition for the first triangle is different than the project condition for the second triangle.

In another embodiment of the invention, a method of providing an electronic graphical presentation of information regarding a project comprising at least three project attributes is provided. A first location within a display workspace is determined along a first axis of a radar graph having three axes. This first location is representative of a value for a first project attribute. A second location within the display workspace is determined along a second axis of the radar graph. This second location is representative of a value for a second project attribute. A third location within the display workspace is determined along a third axis of the radar graph. This third location is representative of a value for a third project attribute. A triangle is then displayed within the display workspace as defined by the first, second and third locations. This triangle may be augmented with one of a color, shade, and pattern scaled to represent a fourth project attribute. This above method can be performed to display two or more triangles where the project condition for the first triangle is different than the project condition for the second triangle. Where there are two or more triangles displayed, each of the triangles is configured on the basis of a common radar graph.

In another embodiment of the invention, a computer system for managing at least one project is provided. This computer system includes a workstation having a processor and a graphical display workspace and a memory associated with the workstation. The memory contains stored program instructions, which are made operable by the processor of the workstation to produce an electronic graphical presentation of project information within the graphical display workspace. The project information includes at least three project attributes. The electronic graphical presentation so displayed includes at least one triangle where a first vertex of the triangle corresponds to a value for a first project attribute measured on the first axis of a radar graph having three axes, a second vertex of the triangle corresponds to a value for a second project attribute measured on a second axis of the radar graph, and a third vertex of the triangle corresponds to a value for a third project attribute measured on a third axis of the radar graph. The triangle may include one of a color, shading and pattern scaled to represent a fourth project attribute.

In another embodiment of the invention, a computer system for managing at least one project is provided. This computer system includes a workstation having a processor and a graphical display workspace. The computer system also includes a memory associated with the workstation. The memory contains stored program instructions, which are made operable by the processor of the workstation to produce an electronic graphical presentation of project information within the graphical display workspace. The project information includes at least three project attributes. The electronic graphical presentation so displayed includes a first triangle and at least a second triangle, each triangle having three vertices and configured on the basis of a common radar graph having three axes. Each of the axes represents a different one of the project attributes. The vertexes of each triangle are positioned at locations on different axes of the radar graph to represent a different quantified project attribute for a predetermined project condition. The project condition for the first triangle is different than the project condition for the second triangle.

The consistent use of quantified metrics through computer software generates the electronic graphic presentation of the present invention and leads to a common lexicon to facilitate communication of project status among a wide audience of users including workers, first level managers, senior managers, stakeholders and executives.

### BRIEF DESCRIPTION OF THE DRAWINGS

The present invention is described in detail below with reference to the following drawings in which like reference numerals refer throughout to like elements.

FIG. 1 is an exemplary display of a triangle, with the axes of a radar graph being shown thereon, in accordance with an embodiment of the invention.

FIG. 2(a) is a sample shading scale that may be applied to a displayed triangle such as that of FIG. 1; and, FIG. 2(b) is a sample pattern scale that may, alternatively, be applied to a displayed triangle such as that of FIG. 1.

FIG. 3 is an exemplary display of two overlapping triangles in accordance with another embodiment of the invention, comparing a sample reference triangle with a triangle for a project plan, both of which are configured on the basis of a common radar graph.

FIG. 4 is an exemplary display of two overlapping triangles in accordance with another embodiment of the invention, comparing a reference triangle to a triangle representing the results to date of a current plan, both of which are configured on the basis of a common radar graph.

FIG. 5 is an exemplary display of two overlaid status triangles in accordance with another embodiment of the invention, but without the visual display of the axes.

FIG. 6 is an exemplary display of a reference triangle and two overlapping triangles displaying different projects in accordance with another embodiment of the invention, where the scale of the axes is set by the reference triangle, and wherein one triangle representing a given “Feature A” and the other triangle representing a given “Feature B” may be compared.

FIG. 7 is an exemplary side-by-side display of reference triangles and two triangles displaying different projects in accordance with another embodiment of the invention where the radar graphs left and right have a common scale and display a common reference triangle, and wherein one triangle representing a given “Feature A” and the other triangle representing a given “Feature B” may be compared.

### DETAILED DESCRIPTION

A system, method, and computer software product for displaying project information are described herein, which could form part of project management user applications. In such applications, a user inputs data for a project into a workstation. The term “project” referenced herein means an individual project, multiple projects, a project segment and/or a project scope. The workstation comprises a processor and a graphical display workspace and is capable of operating in standalone mode or capable of communicating over a network and interacting with other work stations and servers. Commonly, the graphical display workspace is a computer monitor, but it is not limited as such and could include other electronic devices such as telephones and electronic planners. The workstation is also associated with a memory, which can be used to store the input data. The memory also contains program instructions in the form of computer software.

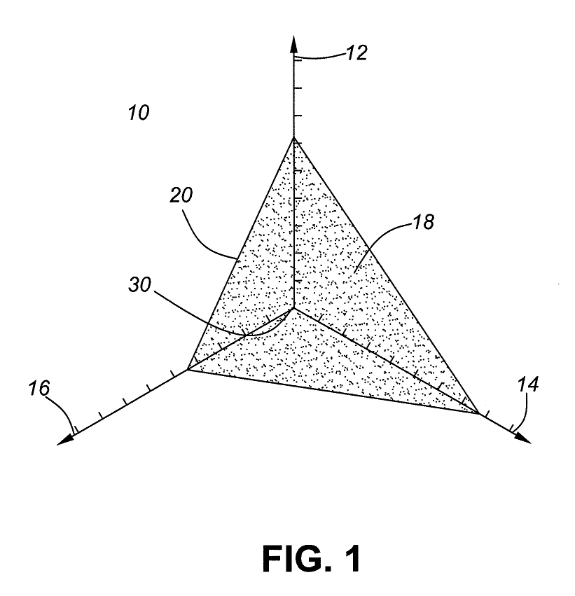

The computer software is embodied in computer-readable media. The computer software uses quantified metrics to generate the electronic graphic presentation described herein. When the software is executed by the workstation, it operates to generate a graphical display (10) within the graphical display workspace, on which is presented a triangle (20) formed on a radar graph (30) having three axes (12, 14, 16). Optionally, the triangle can be further augmented with one of a color, shading, and pattern (surface appearance) (18) as shown in FIG. 1.

In a preferred embodiment, the triangle (20) is a representation of project information under a given set of conditions and displays at least three measured project attributes through its shape and surface appearance (18). A project attribute is a quantifiable quality of interest for a given project. Examples of project attributes are given below.

The shape of the project triangle (20) is defined, in part, by the values of the project attributes for a project under a given set of conditions, as measured on the radar graph (30). The vertical axis (12) of the radar graph (30) is scaled to measure a metric for a first project attribute. In one embodiment, the first attribute may be “Content” with a preferred selection being “Content Merit”, representing a measure of the usefulness and quality of the features or other particulars generated by the execution of the project. The axis to the lower right (14) of the radar graph (30) is scaled to measure a metric for a second project attribute. In one embodiment, the second attribute may be “Schedule” with a preferred selection being “Schedule Duration”, representing a measure of calendar time between the start and the end of the project. The axis to the lower left (16) of the radar graph (30) is scaled to measure a metric for a third attribute. In one embodiment, the third attribute may be “Resources” with a preferred selection being “Resource Energy”, representing a measure of inputs in terms of working hours, skill levels of personnel, equipment, facilities or other capital.

Through the operation of the software, a location on a point of each of the first axis (12), the second axis (14) and the third axis (16) of the radar graph (30) is determined for a given project. The location of each point represents a value of the project attribute assigned with each axis in relation to a given project. These points ultimately form the vertices of the triangle (20).

The shape of the status triangle (20) is further determined by the scaling chosen for the axes in the radar graph (30). The scaling of the axes may be selected as arbitrary values; however, a user may desire to select a consistent scaling to compare the status of different projects.

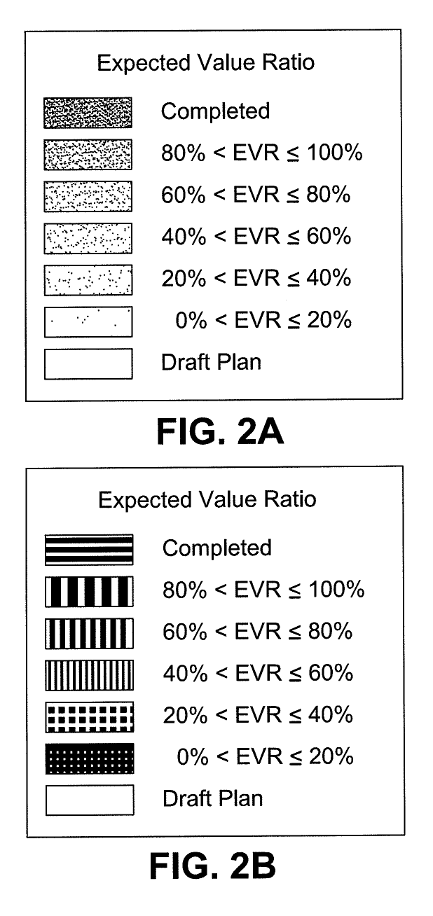

Optionally, one of a color, pattern, and shading (18) is assigned to the triangle (20) which represents a fourth project attribute according to a set scale (see, for example, the scales exemplified by FIGS. 2(a) and 2(b)). In one embodiment, the fourth attribute is “Status” with a preferred selection being the “Expected Value Ratio (EVR)”, representing an evaluation of the expected results of the project considering various uncertainties and risks modeled probabilistically in ratio with an evaluation of their deterministic values. This value is an indication of the likely project results compared to the planned results.

An exemplary shading scale used to define the fourth attribute of the triangle (i.e. surface appearance (18)) is shown in FIG. 2(a). Another scaling option for this same purpose is a pattern scale, as shown in FIG. 2(b). The shading scale and pattern scale illustrated in FIGS. 2(a) and 2(b), respectively, may instead be a color scale. This color scale may be preferred as color is most often quickly perceived and recognized by a user's eye. A color scale that accommodates color blindness may be selected.

In a preferred embodiment, a triangle (20) may display project information in four dimensions, namely “Content”, “Schedule”, “Resources”, and “Status”. Although the example triangle (20) described above has defined the axes of the radar graph (30) as “Content Merit” versus “Schedule Duration” in calendar time versus “Resource Energy” and the surface appearance (18) of the resulting triangle (20) as “Expected Value Ratio (EVR)”, users may select the axes and surface appearance (18) to represent alternate metrics or alternate project attributes. For example, in another application, a user may choose to display “Business Benefit” (representing the impact to the project stakeholders of the features of other particulars expected to be generated by the project) versus “Schedule” (representing a measure in business time between the start and the end of a project measured) versus “Resource Use” (representing the working hours of personnel, equipment, facilities or other capital) or alternatively may choose one or more different attributes, provided there are metrics to quantify those attributes.

The triangle (20) may also serve as a device for users to interact with the underlying project management application to request additional information. For example, when displayed as part of the computer graphical display of a project management application, the user may hover a pointer over regions of the graphic causing the underlying application to display detailed information about that component of the graphic, or users may click on the graphic to open further displays of detailed information about the project. Various other user interactions with the display are also possible.

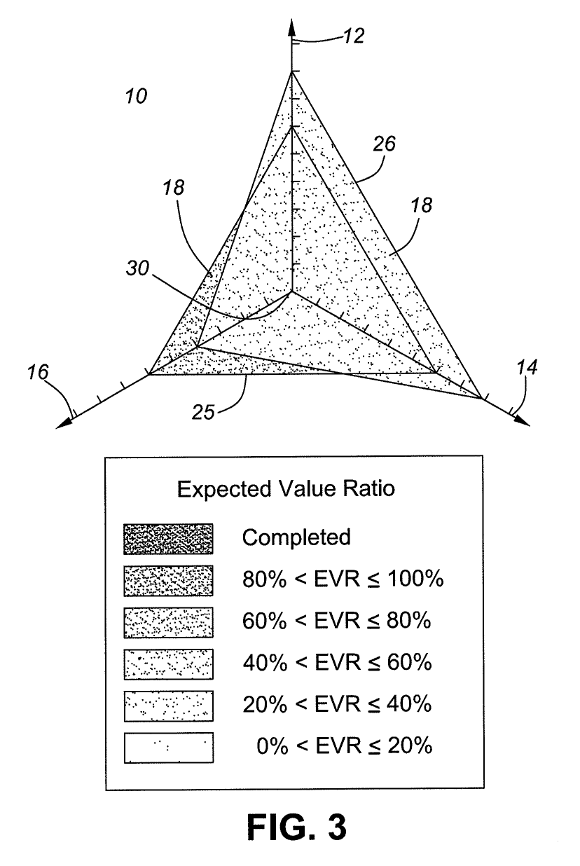

For analyzing project status and comparing projects, one informative embodiment of the computer software described is to display two or more overlapping triangles within the graphical display workspace (10). The triangles displayed are configured to a common radar graph (30) having three axes (12, 14, 16). The axes of the radar graph (30) can be scaled relative to reference indications such as a reference triangle (25). In a preferred embodiment, the axes of the radar graph (30) are normalized such that the base or reference triangle (25) forms an equilateral triangle, as shown in FIG. 3.

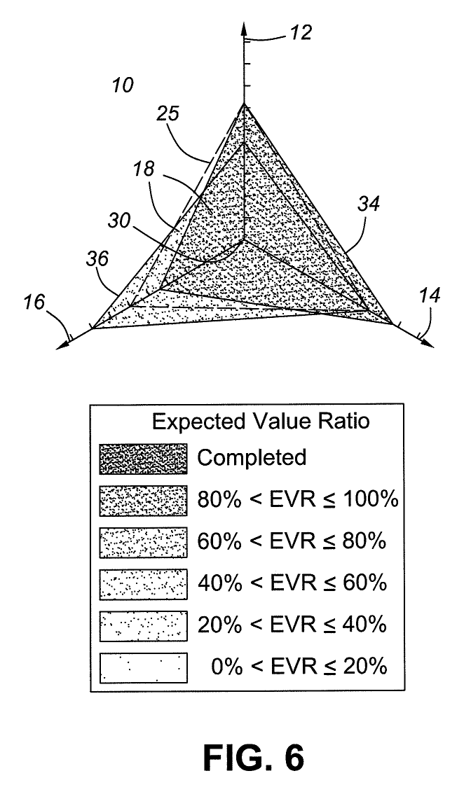

The reference triangle may represent the initial plan for a given project or it may be derived from an average of peer projects, a previous version of a plan for the same project, a view of the project at an alternate time, or a quantitative measure of other measures that indicates quantitatively the value of the attribute being displayed. The reference triangle (25) may be distinguished from other project triangles through the use of a unique border, such as a dashed line (see for example the reference triangle (25) of FIG. 6).

A second triangle, a current status triangle (26), which may represent the actual status of a project according to a current plan, overlays the reference triangle (25). Thus the two triangles may be chosen to represent different perspectives of the same project such as to compare the initially forecast plan to the most current plan. In a preferred embodiment, design of the surface appearance (18) is such that all displayed triangles and their vertices are visible using such techniques as transparency and/or complementary fill patterns.

In FIG. 3, the axes of the radar graph (30) represent “Content” (12), “Schedule” (14), and “Resources” (16) and surface appearance (18) represents “Status” as per the example described above. The information conveyed by the sample display of FIG. 3 is that, relative to the projections of the reference triangle (25) the current status of the project shown by the current status triangle (26) has increased content, will take longer to complete and requires less resources, and the expected results under these conditions is lower.

As project plans change over the life of a project, so to may the project status change. The border of the current status triangle (26) may optionally be augmented to reflect changes or trends in project status. For example, the border to the current status triangle (26) may indicate through border style that its status has improved (e.g. green or solid line) or deteriorated (e.g. red or dotted line) since the previous plan. Other border uses are possible.

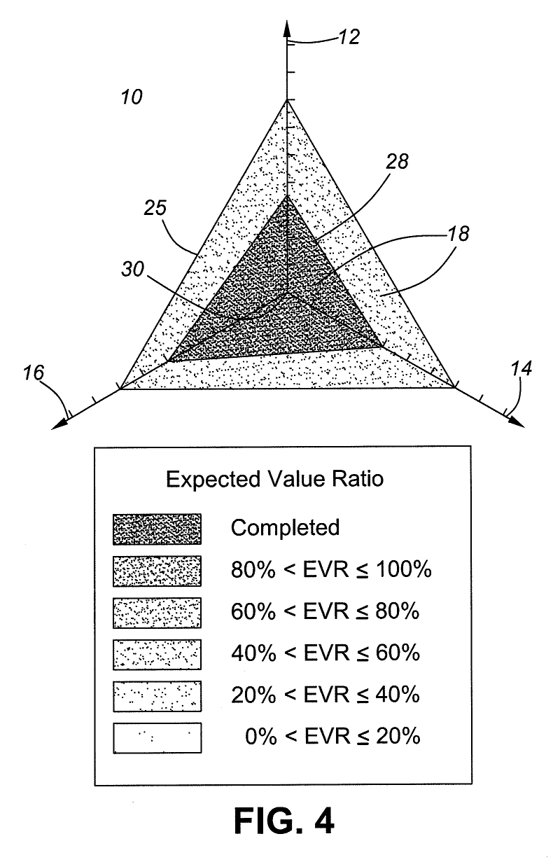

Another useful embodiment of the subject triangle presentation, for purposes of comparison, uses two or more triangles to compare the forecast plan according to an initial draft plan with the actual progress to date on that same project. FIG. 4 shows an example of a graphical display (10), where the axes on the radar graph (30) represent “Content” (12), “Schedule” (14) and “Resources” (16), and the surface appearance (18) is correlated to “Status”, as described per the example above, and comprising a reference triangle (25) representing a reference plan and a triangle (28) representing the actual results of the project at approximately the half-way point of the planned project schedule (see the “Schedule” axis (14)). The graphical display (10) of FIG. 4 instantly conveys to the user the information that, relative to the reference plan (25), approximately half the content has been completed in half the allocated schedule and resources are being consumed at a greater rate than planned. The colors indicate that the reference plan (25) has an EVR between 40-60%. It is a good early warning that adjustments may need to be made to meet the planned objectives.

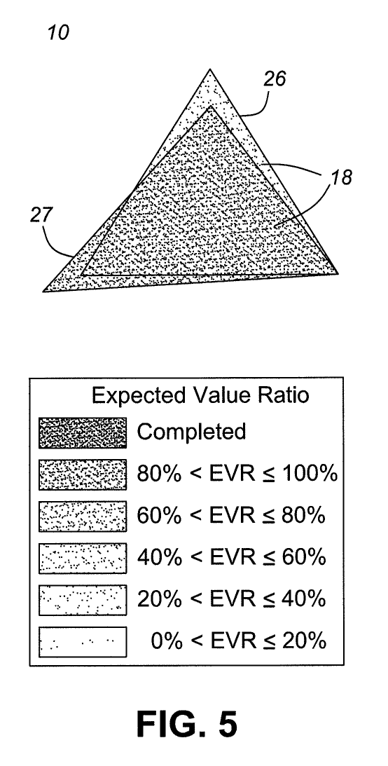

The graphic display (10) need not include a display of the radar graph (30). As shown in FIG. 5, visual comparison of different sets of project conditions using the triangles of the invention may be done without actual display of the radar graph (30). In the example shown in FIG. 5, a current plan triangle (26) and a modified plan triangle (27) are shown overlapped for the purposes of comparison. As in the embodiments of the invention above where the axes are visually displayed, the vertices of the modified plan triangle (27) in FIG. 5 are oriented correspondingly to the vertices of the current plan triangle (26) and in such a manner that the vertices to the top of the triangles correspond to “Content”, the vertices to the lower left of the triangles correspond to “Resources” and the vertices to the lower right of the triangles correspond to “Schedule” as defined above. Again, in this example, the surface appearance (18) of the triangles correlates to “Status”. Even without the axes being marked, it is readily evident for the user to visualize (i.e. interpret the graphic) that by adding more resources and reducing the content of the project, the feasibility of achieving the project in the same schedule duration improves.

Yet another possible application of this presentation is to compare two or more project features, such as to compare two or more project segments representing particular features. The example illustrated in FIG. 6 compares the project attributes of a given “Feature A” (34) to the project attributes of a given “Feature B” (36). By scaling the axes according to a reference triangle (25), it can be seen that, “Feature A” (34) is expected to generate greater content while expending fewer resources over a longer schedule and is more likely to be successful than “Feature B” (36). The information conveyed in this graphic could be useful to managers early in project development when they are deciding between which features to include in a project, for instance.

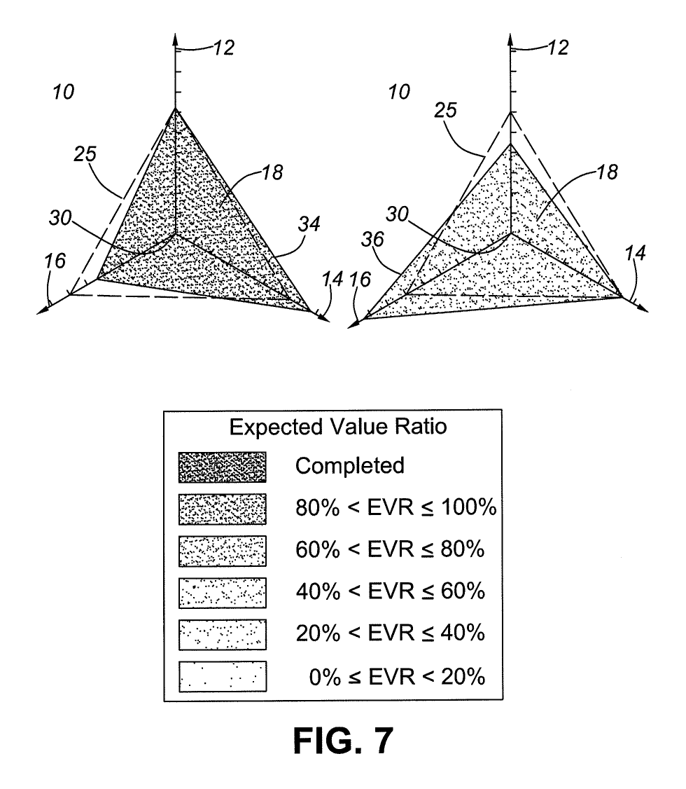

An alternative application for comparatively displaying information such as the information presented in FIG. 6, for example, is to display project information using multiple, similarly configured radar graphs (30) as shown in FIG. 7. As in FIG. 6, the example in FIG. 7 compares the project attributes of a given “Feature A” (34) to the project attributes of a given “Feature B” (36). The radar graphs (30) shown left and right are common in that the axes (12, 14, 16) are defined in the same way and are scaled in the same way. The reference triangles left and right (25) are also common for both radar graphs (30), allowing for direct comparison between “Feature A” (34) and “Feature B” (36). In this way, a comparative display need not show project information as overlapping triangles on one radar graph, provided the radar graphs are defined in the same way.

There are many different alternative software, method and system embodiments that may be devised and implemented to produce a display of overlapping triangles as described above. Advantageously, the versatility and relatively high information content of the triangle display provided by the invention enables users to test and visually compare the consequences of varying the conditions of a project to assist in determining project strategy. Further, the display may be extended to three or more triangles in a straightforward manner, to compare three or more project scenarios at a time.

The foregoing examples of the embodiments of the invention are provided only for the purposes of describing the invention and are not intended to limit the scope of the invention claimed herein. Rather, the invention in which an exclusive property or privilege is claimed is defined as set forth in the following pages.

What is claimed is:

1. Computer software configured for presenting information regarding a project comprising at least four project attributes, the computer software being embodied in computer-readable media and when executed being operable to display within a graphical display workspace at least one triangle comprising three vertices and configured on the basis of a radar graph, said radar graph having three axes, where each of the axes represents a different one of the project attributes and each vertex of the triangle is positioned at a location on a different one of the axes to represent a different quantified project attribute for a predetermined project condition, and said triangle comprises one of a color, shading and pattern scaled to represent a fourth quantified project attribute.

2. Computer software according to claim 1 and, when executed, being further operable to display the axes of the radar graph within the graphical display workspace.

3. Computer software according to claim 1, wherein the first of the three axes of the radar graph is scaled to measure a metric for project content, the second of the three axes of the radar graph is scaled to measure a metric for project schedule, the third of the three axes of the radar graph is scaled to measure a metric for project resources and the one of a color, shading and pattern is scaled to measure a metric for project status.

4. Computer software configured for presenting information pertaining to one or more projects, each said project comprising at least three project attributes, the computer software being embodied in computer-readable media and when executed being operable to display within a graphical display workspace a first triangle and at least a second triangle, each said triangle comprising three vertices and configured on the basis of a common radar graph having three axes representing a different one of the project attributes, and the vertexes of each triangle being positioned at locations on different axes of said radar graph to represent a different quantified project attribute for a predetermined project condition whereby said project condition for the first triangle is different than the project condition for the second triangle.

5. Computer software according to claim 4 and, when executed, being further operable to display the axes of the radar graphs within the graphical display workspace.

6. Computer software according to claim 4, which operates to display within the graphical display workspace each triangle overlapping on a common radar graph, said radar graph having three axes, each of the axes corresponding to one of the at least three project attributes.

7. Computer software according to claim 4 wherein for each triangle displayed within the workspace, a first vertex represents a first project attribute measured on the first axis of the radar graph, a second vertex represents a second project attribute measured on the second axis of the radar graph, and a third vertex represents a third project attribute measured on the third axis of the radar graph, the shape of each of the triangles displayed thereby representing three quantified project attributes of a project under a distinct set of project conditions.

8. Computer software according to claim 7, wherein the first of the three axes of the radar graph is scaled to measure a metric for project content, the second of the three axes of the radar graph is scaled to measure a metric for project schedule, and the third of the three axes of the radar graph is scaled to measure a metric for project resources.

9. Computer software according to claim 7, wherein at least one of the triangles comprises one of a color, shading and pattern scaled to represent a fourth quantified project attribute.

10. Computer software according to claim 9, wherein the first of the three axes of the radar graph is scaled to measure a metric for project content, the second of the three axes of the radar graph is scaled to measure a metric for project schedule, the third of the three axes of the radar graph is scaled to measure a metric for project resources and the one of a color, shading and pattern is scaled to measure a metric for project status.

11. Computer software according to claim 4, wherein the first triangle is a reference triangle.

12. Computer software according to claim 11, wherein the reference triangle is for a project condition being an initial plan for the project.

13. Computer software according to claim 11, wherein the reference triangle is derived from an average of similar projects.

14. Computer software according to claim 11, wherein the reference triangle is derived from a previous plan of the same project.

15. Computer software according to claim 11, wherein the reference triangle is an equilateral triangle based on a normalization of the scales of the three axes of the radar graph.

16. Computer software according to claim 11, wherein at least one of the displayed triangles comprises a distinguishing border.

17. Computer software according to claim 4, wherein at least one of the displayed triangles represents quantified results of the project that have been completed prior to a specified date.

18. A method of providing an electronic graphical presentation of information regarding a project comprising at least four project attributes, said method comprising the steps of:
(a) determining a first location within a display workspace along a first axis of a radar graph which is representative of a value for a first project attribute, said radar graph comprising three axes; determining a second location within the display workspace along a second axis of the radar graph which is representative of a value for a second project attribute; determining a third location within the display workspace along a third axis of the radar graph which is representative of a value for a third project attribute; and,
(b) displaying within the display workspace a triangle defined by the first, second and third locations and comprising one of a color, shade and pattern scaled to represent a fourth project attribute.

19. A method of comparing information pertaining to one or more projects, each project comprising at least three project attributes, said method comprising displaying within a graphical display workspace a first triangle and at least a second triangle, each said triangle comprising three vertices and configured on the basis of a common radar graph, said radar graph having three axes representing a different one of the project attributes, and the vertexes of each triangle being positioned at locations on different axes of said radar graph to represent a different quantified project attribute for a predetermined project condition whereby said project condition for the first triangle is different than the project condition for the second triangle.

20. A method according to claim 19, wherein at least one of the triangles comprises one of a color, shade and pattern scaled to represent a fourth project attribute.

21. A method according to claim 20, wherein the first of the three axes of the radar graph is scaled to measure a metric for project content, the second of the three axes of the radar graph is scaled to measure a metric for project schedule, the third of the three axes of the radar graph is scaled to measure a metric for project resources and for at least one of the triangles the one of a color, shading and pattern is scaled to measure a metric for project status.

22. A computer system for managing at least one project comprising:
a workstation comprising a processor and a graphical display workspace;
a memory associated with the workstation and containing stored program instructions, the stored program instructions operable by the processor of the workstation to produce an electronic graphical presentation of project information within the graphical display workspace, the project information comprising at least four project attributes, said electronic graphical presentation comprising:
at least one triangle where a first vertex of the triangle corresponds to a value for a first project attribute measured on the first axis of a radar graph, said radar graph comprising three axes, a second vertex of the triangle corresponds to a value for a second project attribute measured on a second axis of the radar graph, and a third vertex of the triangle corresponds to a value for a third project attribute measured on a third axis of the radar graph and the triangle comprises one of a color, shading and pattern scaled to represent a fourth project attribute.

23. A computer system according to claim 22 wherein the radar graph is segmented into three parts by a first axis, a second axis, and a third axis, each of the axes being scaled to measure one of the project attributes.

24. A computer system for managing one or more projects comprising:
a workstation comprising a processor and a graphical display workspace;
a memory associated with the workstation and containing stored program instructions, the stored program instructions operable by the processor of the workstation to produce an electronic graphical presentation of project information within the graphical display workspace, each said project comprising at least three project attributes, said electronic graphical presentation comprising:
a first triangle and at least a second triangle, each said triangle comprising three vertices and configured on the basis of a common radar graph having three axes, each axis representing a different one of the project attributes, and the vertexes of each triangle being positioned at locations on different axes of said radar graph to represent a different quantified project attribute for a predetermined project condition whereby said project condition for the first triangle is different than the project condition for the second triangle.

25. A computer system according to claim 24 wherein at least one of the triangles comprises one of a color, shading and pattern scaled to represent a fourth project attribute.

26. A computer system according to claim 25 wherein the first of the three axes of the radar graph is scaled to measure a metric for project content, the second of the three axes of the radar graph is scaled to measure a metric for project schedule, the third of the three axes of the radar graph is scaled to measure a metric for project resources and for at least one of the triangles the one of a color, shading and pattern is scaled to measure a metric for project status.
